(19) United States
(12) Patent Application Publication
(10) Pub. No.: US 2024/0145888 A1
(43) Pub. Date: May 2, 2024

(54) Battery Cell for an Electrical Energy Storage Device for Installation in an Electrified Motor Vehicle

(71) Applicant: Bayerische Motoren Werke Aktiengesellschaft, Muenchen (DE)

(72) Inventor: Joachim FROESCHL, Herrsching (DE)

(21) Appl. No.: 18/278,691

(22) PCT Filed: Mar. 22, 2022
(86) PCT No.: PCT/EP2022/057398

§ 371 Date: Aug. 24, 2023

(30) Foreign Application Priority Data
Apr. 22, 2021 (DE) 10 2021 110 219.7

(51) Int. Cl. H01M 50/59; B60L 3/00; B60L 50/64; H01M 10/04; H01M 50/107; H01M 50/213; H01M 50/342

(52) U.S. Cl. CPC H01M 50/59; B60L 3/0046; B60L 50/64; H01M 10/0431; H01M 50/107; H01M 50/213; H01M 50/3425; H01M 2200/10; H01M 2220/20

(57) ABSTRACT

A battery cell for an electrical energy storage device for installation in an electrified motor vehicle having a large number of battery cells. The battery cell includes a cell core and a hybrid cell housing. The hybrid cell housing includes an inner housing element with an outer housing element, and a protection apparatus, by way of which the cell core together with the inner housing element can be ejected from the outer housing element in the event of a (preferably thermal) fault. The outer housing element may include a gas-tight closure in the direction opposite to the ejection direction, the gas-tight closure creating a gas-tight cavity in which, for example in the case of an event that leads to the inner housing element bursting, pressure is deliberately created by gas and used to eject the inner housing element in the ejection direction.

### FIELD

The invention relates to a battery cell for an electrical energy storage device for installation in an electrified motor vehicle (electric vehicle or hybrid vehicle), in particular for a lithium-ion storage device which is used, for example, as onboard batteries, high-voltage storage devices, or traction batteries.

### BACKGROUND AND SUMMARY

The not previously published German patent application by the Applicant with the official reference number DE 10 2020 126 424 discloses an energy storage device (in the form of a lithium-ion storage device) which has a “cell pack” in a housing with a large number of battery cells (individual storage cells) which are oriented vertically with respect to the underside of the vehicle. The battery cells are, for the purpose of stabilization against forces acting from below, integrated into a frame of support elements which act as force-absorbing housing extensions of the cells.

The not previously published DE 10 2021 102 017 of the Applicant relates to an electrical energy storage device for installation in an electrified motor vehicle with a large number of battery cells, wherein each battery cell consists of a cell core and a hybrid cell housing which is configured by an inner subhousing in the form of an inner cell wall made from electrically insulating material and by an outer subhousing in the form of a cell holder made from electrically conductive and thermally conductive material. The first and the second subhousing thus form a hybrid cell housing (hybrid housing) by being connected to each other mechanically.

An object of the invention is to develop a battery cell for an energy storage device of the type mentioned at the beginning in terms of temperature events.

This object is achieved by the features as disclosed herein. The present disclosure also includes advantageous developments of the invention.

The invention relates to a battery cell for an electrical energy storage device (in particular for installation in an electrified motor vehicle) with a large number of battery cells. The battery cell according to the invention consists of a cell core and a hybrid cell housing. The hybrid cell housing is configured as a combination of an inner subhousing with an outer subhousing, wherein a protection apparatus is provided by means of which, in the event of a (preferably thermal) fault, the cell core with the inner subhousing can be ejected from the outer subhousing.

The outer subhousing particularly preferably has, in the opposite direction to the ejection direction, a seal by means of which a gas-tight cavity is created in which, by introducing gas (for example, in the case of an event which causes the inner subhousing to burst with the escape of gas, or in the case of additional use of a “miniature airbag” which is defined more precisely below), pressure can be built up in a targeted fashion and used to eject the inner subhousing in the ejection direction.

The invention is based on the following considerations:

### PRIOR ART

The present invention is preferably based on a cell system which is described in the not previously published DE 10 2020 126 424 of the Applicant.

### Problem

In the case of an electrical storage cell, a fault can cause a short-term release of a high amount of energy with uncertain damaging consequences.

### Subject of the Present Invention

A cell system with a protective function is proposed. The protective function consists in it being possible, in the event of cell failure occurring as a result of the release of high amounts of energy and the resulting overheating of a battery cell, for this cell to be ejected from the cell stack and storage system.

In order to reduce weight, the battery cell according to the invention preferably consists of a cell core (of any design, for example as an electrode winding) and a hybrid cell housing (hybrid housing) similar to the subject-matter of the not previously published DE 10 2020 126 424. The hybrid cell housing is designed with an inner cell wall (inner subhousing) and with an outer cell holder made from thermally conductive metal (outer subhousing). The hybrid housing thus consists of two subhousings. The plastic inner subhousing is light and results in a reduction in weight. The outer subhousing consists of thermally conductive metal and is thus suitable for tempering. The two subhousings together additionally contribute to stabilization against mechanical forces. The battery cell according to the invention can, however, also consist of two subhousings of a different type.

The operating strategy of an electronic control device for the energy storage device can, in combination with a suitable sensor system, store a location or identification of the ejected cell. The electrical energy flows (supply or discharge of energy) through the cell holder are preferably activated by a storage management system as a software program module in the electronic control device.

An exemplary embodiment of the invention is illustrated in the drawings.

### BRIEF DESCRIPTION OF THE DRAWINGS

FIG. 1 shows components of a battery cell according to the invention with a protection apparatus for ejection in the event of a thermal fault,

FIG. 2 shows a first state of the battery cell according to the invention during an ejection procedure through an obstacle (for example, through the base of an energy storage device),

FIG. 3 shows a second state of the battery cell according to the invention during an ejection procedure through an obstacle, and

FIG. 4 shows the state in particular of the outer subhousing of the battery cell according to the invention once ejection is complete.

### DETAILED DESCRIPTION

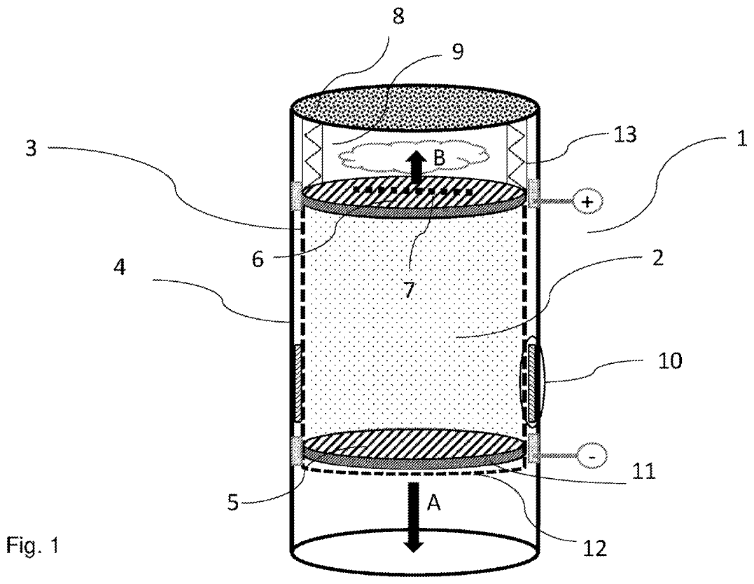

FIG. 1 shows the schematic structure of a battery cell 1 (storage cell) with a hybrid housing. The exemplary embodiments relate to round battery cells. The present disclosure can, however, also be applied for other, for example prismatic, battery cells. The cell 1 has, for example, two electrically conductive contacting covers 5 and 6 and a plastic (for example, PP, PTFE) cylinder as the inner subhousing 3 of the hybrid cell housing. The operational stability of the cell 1 is achieved by the combination of the inner subhousing 3 with an outer subhousing 4 in the form of a cell holder.

FIG. 1 shows a side view of the schematic integration of the inner subhousing 3, which is a cell wall of the cell core 2, into the outer subhousing 4 in the form of a cell holder.

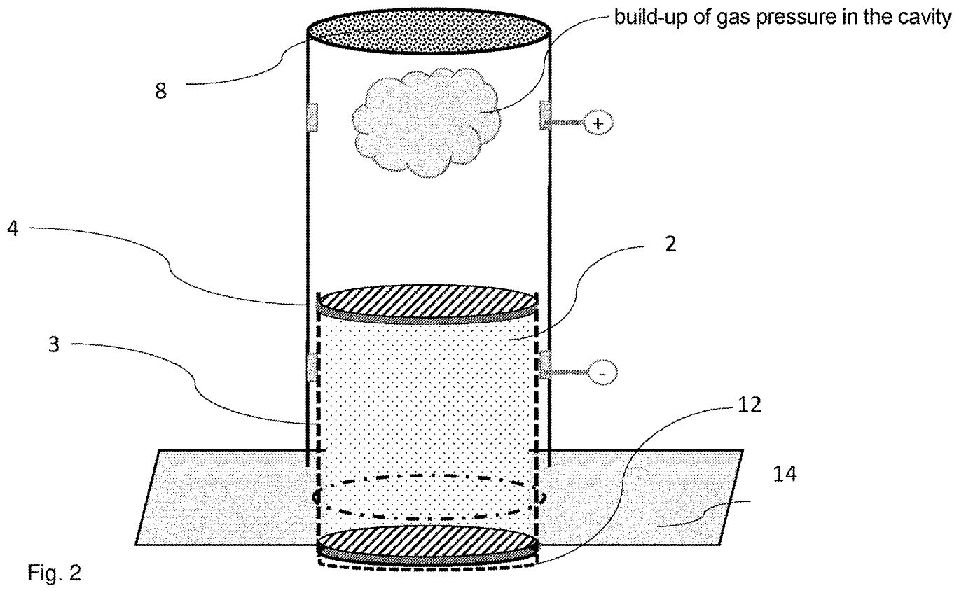

In this hybrid cell structure, a sliding layer 10, for example Teflon PTFE, which can reduce the friction in the case of an ejection, is preferably provided between the cylinders or subhousings 3 and 4. The cell stack or the storage system with a large number of battery cells 1 according to the present disclosure are here not shown in their entirety but a possible base of such a cell stack or storage system is illustrated schematically in FIGS. 2 to 4. The inner cylinder or subhousing 3 is preferably electrically contacted and locked or fastened in the outer cylinder or subhousing 4 by means of a circumferential electrically conductive bead 11. The contacting and arrangement of a plurality of cells in a series connection, for example the alternating cell orientation “ . . . +−+− . . .”, are also not shown because this is known. A non-cylindrical cell shape, for example prismatic, is also comprised by the present disclosure but is not specifically illustrated here. The contacting cover 6, facing in the opposite direction B to the ejection direction A, of the cell 1 is preferably provided with a predetermined breaking point 7 in order to direct the escaping gases into the upper cavity in the event of a fault.

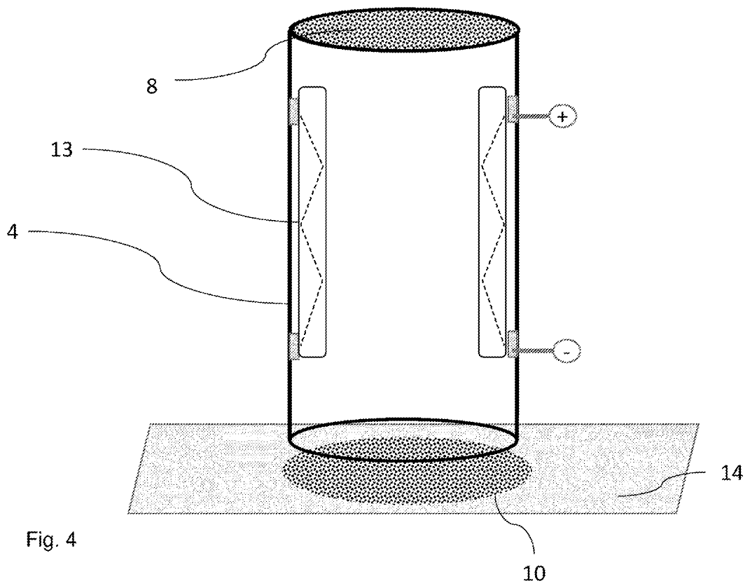

FIG. 4 describes a spring apparatus 13 in the upper gas-tight cavity 9. The spring apparatus 13 can assist the ejection of the inner subhousing 3 with its pretension in the event of a fault.

The cloud shown in FIGS. 1 and 2 indicates the escape of gas into the cavity 9 in the event of a fault.

FIG. 1 illustrates the build-up of gas pressure in the event of a fault and FIGS. 2 to 4 illustrate the movement caused as a result of the inner subhousing 3 in the case of the cell or cell core being ejected. To be more precise, the ejection of the cell is the ejection of the inner subhousing 3 with the integrated cell core 2.

FIGS. 2 to 4 show the penetration of the base 14 of the storage device arrangement by the inner subhousing 3, assuming a vertical storage device/cell structure.

FIGS. 1 and 2 show, in an advantageous development of the present disclosure, a circumferential cutting apparatus 12 on the inner subhousing 3 for assisting the penetration of the base 14 by the inner subhousing 3.

FIG. 2 illustrates in dashed lines a predetermined breaking point in the base 14 of the storage system. This also assists the penetration of the base 14.

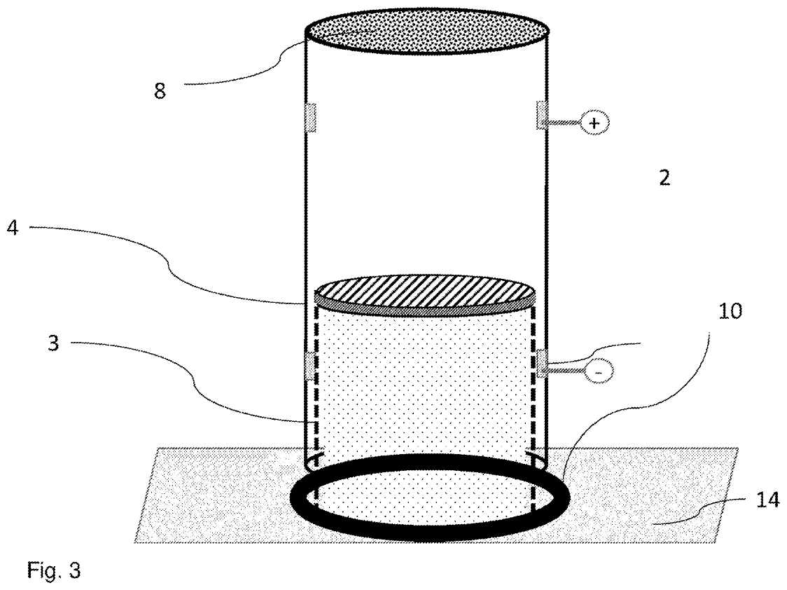

A further advantageous embodiment is shown in FIG. 3. Here, either a reservoir with expanding material, for example polyurethane foam, comparable with the functioning of a spray can for construction applications, is provided in the base 14 or the outflowing sliding material 10 is configured as expanding and/or adhesive material. In the event of a fault, the expansion is initiated by the ejection such that the base 14 is resealed after the ejection in order, for example, to prevent the ingress of foreign substances (for example, water) after the ejection procedure. The seal achieved as a result is illustrated in FIG. 4.

The creation of an emergency operating feature of the storage system is also shown in FIG. 4. The emergency operating feature consists in bypassing the damaged cell 1 or electrical bypass contacting in the case of ejection of the cell 1, i.e. the removal of the cell 1.

The spring apparatus 13 in FIG. 1 creates, in its untensioned state, contacting of the upper and lower circumferential beads 11 and hence electrical cell contacting inside the cell array. It is thus ensured in the event of a fault that the series connection of the cells is maintained. The storage device arrangement thus remains functional for emergency operation with an overall voltage reduced by a cell voltage. This can furthermore be communicated to an energy management system by a sensor apparatus (not shown in detail). Adaptation of the operating strategy of the higher-order system is thus possible. The higher-order system can be an electric drive of a vehicle or an electric onboard power system of a vehicle which can also be used later in the case of so-called “second life” use as a stationary energy storage system of a building.

An electronic control unit of the energy management system can recognize the ejection per se, the location of the cell ejection, and/or the identification of the ejected cell 1.

The details of the present disclosure are explained below again in different words with the aid of FIGS. 1 to 4 including the possible advantageous developments:

FIG. 1 shows a battery cell 1 according to the present disclosure for an electrical energy storage device for installation in an electrified motor vehicle with a large number of battery cells. The battery cell 1 consists of a cell core 2 and a hybrid cell housing which is configured as a combination of an inner subhousing 3 in the form of an inner cell wall made from electrically insulating material and an outer subhousing 4 in the form of a cell holder made from electrically conductive material. In particular, the contacting cover 6 with an optional predetermined breaking point 7, the wall of the outer subhousing 4, and the gas-tight seal 8 of the outer subhousing 4 form a protection apparatus by means of which, in the event of a (in particular thermal) fault, the cell core 2 with the inner subhousing 3 can be ejected from the outer subhousing 4.

The outer subhousing 4 is open in the ejection direction A but sealed gas-tightly in the opposite direction B to the ejection direction A, for example by a cover 8. The inner subhousing 3 with the cell core 2 is arranged in the outer subhousing 4 in such a way that, between the inner subhousing 3 and the seal 8, a gas-tight cavity 9 is created in which, in the case of a thermal event which causes the inner subhousing 3 to burst, pressure is created by the escaping hot gas and can be used to eject the inner subhousing 3 in the ejection direction A.

Also conceivable is an additional gas-generating unit (“miniature airbag”, see also above) in the region of the predetermined breaking point 7. This can, for example, be an igniter, comparable to an airbag system, or a chemical substance which generates additional gas (for example, by decomposition of the substance) in the event of a temperature threshold being exceeded. This would have the advantage that, before the cell bursts, the cell can already be ejected predictively because of an unacceptably elevated temperature in order to reduce secondary damage.

The inner subhousing 3 has a first contacting cover 5 with no material weakness in the ejection direction A, and a second contacting cover 6 with material weakness in the opposite direction B, in this case with a predetermined breaking point 7.

An electrically conductive spring apparatus 13 is preferably pretensioned in the gas-tight cavity 9 in such a way that, after ejection, it serves in the untensioned state as a contact bypass (see FIG. 4 and the preceding description of this above).

A sliding material 10, which is configured for example simultaneously as an expanding and/or adhesive material with a predetermined viscosity and hardenability, can be introduced between the inner subhousing 3 and the outer subhousing 4 in order to seal the base 14 after an ejection (see FIG. 3 and FIG. 4).

A bead 11 for the positive pole (+) and the negative pole (−) is provided in each case on the inner subhousing 3 for locking it to the outer subhousing 4 in both a retaining and electrically contacting fashion.

If it is not possible for the ejection to take place unhindered, for example into a collection tank, and instead, for example, a/the base of 14 of a cell pack has to be perforated, the inner subhousing 3 can have a cutting apparatus 12 in the ejection direction A.

In summary, with this arrangement both greater damage in the storage system and the adjacent systems and components can be prevented and the functionality maintained to a limited extent. The latter affords an advantageous degree of safety in the case of autonomous driving.

### Battery Cell for an Electrical Energy Storage Device for Installation in an Electrified Motor Vehicle

The invention relates to a battery cell for an electrical energy storage device for installation in an electrified motor vehicle (electric vehicle or hybrid vehicle), in particular for a lithium-ion storage device which is used, for example, as onboard batteries, high-voltage storage devices, or traction batteries.

The not previously published German patent application by the Applicant with the official reference number DE 10 2020 126 424 discloses an energy storage device (in the form of a lithium-ion storage device) which has a “cell pack” in a housing with a large number of battery cells (individual storage cells) which are oriented vertically with respect to the underside of the vehicle. The battery cells are, for the purpose of stabilization against forces acting from below, integrated into a frame of support elements which act as force-absorbing housing extensions of the cells.

The not previously published DE 10 2021 102 017 of the Applicant relates to an electrical energy storage device for installation in an electrified motor vehicle with a large number of battery cells, wherein each battery cell consists of a cell core and a hybrid cell housing which is configured by an inner subhousing in the form of an inner cell wall made from electrically insulating material and by an outer subhousing in the form of a cell holder made from electrically conductive and thermally conductive material. The first and the second subhousing thus form a hybrid cell housing (hybrid housing) by being connected to each other mechanically.

The object of the invention is to develop a battery cell for an energy storage device of the type mentioned at the beginning in terms of temperature events.

This object is achieved by the features of patent claim 1. The dependent patent claims are advantageous developments of the invention.

The invention relates to a battery cell for an electrical energy storage device (in particular for installation in an electrified motor vehicle) with a large number of battery cells. The battery cell according to the invention consists of a cell core and a hybrid cell housing. The hybrid cell housing is configured as a combination of an inner subhousing with an outer subhousing, wherein a protection apparatus is provided by means of which, in the event of a (preferably thermal) fault, the cell core with the inner subhousing can be evaluated from the outer subhousing.

The outer subhousing particularly preferably has, in the opposite direction to the ejection direction, a seal by means of which a gas-tight cavity is created in which, by introducing gas (for example, in the case of an event which causes the inner subhousing to burst with the escape of gas, or in the case of additional use of a “miniature airbag” which is defined more precisely below), pressure can be built up in a targeted fashion and used to eject the inner subhousing in the ejection direction.

The invention is based on the following considerations:

### Prior Art

The present invention is preferably based on a cell system which is described in the not previously published DE 10 2020 126 424 of the Applicant.

### Problem

In the case of an electrical storage cell, a fault can cause a short-term release of a high amount of energy with uncertain damaging consequences.

### Subject of the Present Invention

A cell system with a protective function is proposed. The protective function consists in it being possible, in the event of cell failure occurring as a result of the release of high amounts of energy and the resulting overheating of a battery cell, for this cell to be ejected from the cell stack and storage system.

In order to reduce weight, the battery cell according to the invention preferably consists of a cell core (of any design, for example as an electrode winding) and a hybrid cell housing (hybrid housing) similar to the subject-matter of the not previously published DE 10 2020 126 424. The hybrid cell housing is designed with an inner cell wall (inner subhousing) and with an outer cell holder made from thermally conductive metal (outer subhousing). The hybrid housing thus consists of two subhousings. The plastic inner subhousing is light and results in a reduction in weight. The outer subhousing consists of thermally conductive metal and is thus suitable for tempering. The two subhousings together additionally contribute to stabilization against mechanical forces. The battery cell according to the invention can, however, also consist of two subhousings of a different type.

The operating strategy of an electronic control device for the energy storage device can, in combination with a suitable sensor system, store a location or identification of the ejected cell. The electrical energy flows (supply or discharge of energy) through the cell holder are preferably activated by a storage management system as a software program module in the electronic control device.

An exemplary embodiment of the invention is illustrated in the drawings, in which:

FIG. 1 shows the essential components of a battery cell according to the invention with a protection apparatus for ejection in the event of a thermal fault,

FIG. 2 shows a first state of the battery cell according to the invention during an ejection procedure through an obstacle (for example, through the base of an energy storage device),

FIG. 3 shows a second state of the battery cell according to the invention during an ejection procedure through an obstacle, and

FIG. 4 shows the state in particular of the outer subhousing of the battery cell according to the invention once ejection is complete.

FIG. 1 shows the schematic structure of a battery cell 1 (storage cell) with a hybrid housing. The exemplary embodiments relate to round battery cells. The invention can, however, also be applied for other, for example prismatic, battery cells. The cell 1 has, for example, two electrically conductive contacting covers 5 and 6 and a plastic (for example, PP, PTFE) cylinder as the inner subhousing 3 of the hybrid cell housing. The operational stability of the cell 1 is achieved by the combination of the inner subhousing 3 with an outer subhousing 4 in the form of a cell holder.

FIG. 1 shows a side view of the schematic integration of the inner subhousing 3, which is a cell wall of the cell core 2, into the outer subhousing 4 in the form of a cell holder.

In this hybrid cell structure, a sliding layer 10, for example Teflon PTFE, which can reduce the friction in the case of an ejection, is preferably provided between the cylinders or subhousings 3 and 4. The cell stack or the storage system with a large number of battery cells 1 according to the invention are here not shown in their entirety but a possible base of such a cell stack or storage system is illustrated schematically in FIGS. 2 to 4. The inner cylinder or subhousing 3 is preferably electrically contacted and locked or fastened in the outer cylinder or subhousing 4 by means of a circumferential electrically conductive bead 11. The contacting and arrangement of a plurality of cells in a series connection, for example the alternating cell orientation “ . . . +−+− . . . ”, are also not shown because this is known. A non-cylindrical cell shape, for example prismatic, is also comprised by the invention but is not specifically illustrated here. The contacting cover 6, facing in the opposite direction B to the ejection direction A, of the cell 1 is preferably provided with a predetermined breaking point 7 in order to direct the escaping gases into the upper cavity in the event of a fault.

FIG. 4 describes a spring apparatus 13 in the upper gas-tight cavity 9. The spring apparatus 13 can assist the ejection of the inner subhousing 3 with its pretension in the event of a fault.

The cloud shown in FIGS. 1 and 2 indicates the escape of gas into the cavity 9 in the event of a fault.

FIG. 1 illustrates the build-up of gas pressure in the event of a fault and FIGS. 2 to 4 illustrate the movement caused as a result of the inner subhousing 3 in the case of the cell or cell core being ejected. To be more precise, the ejection of the cell is the ejection of the inner subhousing 3 with the integrated cell core 2.

FIGS. 2 to 4 show the penetration of the base 14 of the storage device arrangement by the inner subhousing 3, assuming a vertical storage device/cell structure.

FIGS. 1 and 2 show, in an advantageous development of the invention, a circumferential cutting apparatus 12 on the inner subhousing 3 for assisting the penetration of the base 14 by the inner subhousing 3.

FIG. 2 illustrates in dashed lines a predetermined breaking point in the base 14 of the storage system. This also assists the penetration of the base 14.

A further advantageous embodiment is shown in FIG. 3. Here, either a reservoir with expanding material, for example polyurethane foam, comparable with the functioning of a spray can for construction applications, is provided in the base 14 or the outflowing sliding material 10 is configured as expanding and/or adhesive material. In the event of a fault, the expansion is initiated by the ejection such that the base 14 is resealed after the ejection in order, for example, to prevent the ingress of foreign substances (for example, water) after the ejection procedure. The seal achieved as a result is illustrated in FIG. 4.

The creation of an emergency operating feature of the storage system is also shown in FIG. 4. The emergency operating feature consists in bypassing the damaged cell 1 or electrical bypass contacting in the case of ejection of the cell 1, i.e. the removal of the cell 1.

The spring apparatus 13 in FIG. 1 creates, in its untensioned state, contacting of the upper and lower circumferential beads 11 and hence electrical cell contacting inside the cell array. It is thus ensured in the event of a fault that the series connection of the cells is maintained. The storage device arrangement thus remains functional for emergency operation with an overall voltage reduced by a cell voltage. This can furthermore be communicated to an energy management system by a sensor apparatus (not shown in detail). Adaptation of the operating strategy of the higher-order system is thus possible. The higher-order system can be an electric drive of a vehicle or an electric onboard power system of a vehicle which can also be used later in the case of so-called “second life” use as a stationary energy storage system of a building.

An electronic control unit of the energy management system can recognize the ejection per se, the location of the cell ejection, and/or the identification of the ejected cell 1.

The details of the invention are explained below again in different words with the aid of FIGS. 1 to 4 including the possible advantageous developments:

FIG. 1 shows a battery cell 1 according to the invention for an electrical energy storage device for installation in an electrified motor vehicle with a large number of battery cells. The battery cell 1 consists of a cell core 2 and a hybrid cell housing which is configured as a combination of an inner subhousing 3 in the form of an inner cell wall made from electrically insulating material and an outer subhousing 4 in the form of a cell holder made from electrically conductive material. In particular, the contacting cover 6 with an optional predetermined breaking point 7, the wall of the outer subhousing 4, and the gas-tight seal 8 of the outer subhousing 4 form a protection apparatus by means of which, in the event of a (in particular thermal) fault, the cell core 2 with the inner subhousing 3 can be evaluated from the outer subhousing 4.

The outer subhousing 4 is open in the ejection direction A but sealed gas-tightly in the opposite direction B to the ejection direction A, for example by a cover 8. The inner subhousing 3 with the cell core 2 is arranged in the outer subhousing 4 in such a way that, between the inner subhousing 3 and the seal 8, a gas-tight cavity 9 is created in which, in the case of a thermal event which causes the inner subhousing 3 to burst, pressure is created by the escaping hot gas and can be used to eject the inner subhousing 3 in the ejection direction A.

Also conceivable is an additional gas-generating unit (“miniature airbag”, see also above) in the region of the predetermined breaking point 7. This can, for example, be an igniter, comparable to an airbag system, or a chemical substance which generates additional gas (for example, by decomposition of the substance) in the event of a temperature threshold being exceeded. This would have the advantage that, before the cell bursts, the cell can already be ejected predictively because of an unacceptably elevated temperature in order to reduce secondary damage.

The inner subhousing 3 has a first contacting cover 5 with no material weakness in the ejection direction A, and a second contacting cover 6 with material weakness in the opposite direction B, in this case with a predetermined breaking point 7.

An electrically conductive spring apparatus 13 is preferably pretensioned in the gas-tight cavity 9 in such a way that, after ejection, it serves in the untensioned state as a contact bypass (see FIG. 4 and the preceding description of this above).

A sliding material 10, which is configured for example simultaneously as an expanding and/or adhesive material with a predetermined viscosity and hardenability, can be introduced between the inner subhousing 3 and the outer subhousing 4 in order to seal the base 14 after an ejection (see FIG. 3 and FIG. 4).

A bead 11 for the positive pole (+) and the negative pole (−) is provided in each case on the inner subhousing 3 for locking it to the outer subhousing 4 in both a retaining and electrically contacting fashion.

If it is not possible for the ejection to take place unhindered, for example into a collection tank, and instead, for example, a/the base of 14 of a cell pack has to be perforated, the inner subhousing 3 can have a cutting apparatus 12 in the ejection direction A.

In summary, with this arrangement both greater damage in the storage system and the adjacent systems and components can be prevented and the functionality maintained to a limited extent. The latter affords an advantageous degree of safety in the case of autonomous driving.

1-8. (canceled)

9. A battery cell for an electrical energy storage device with a plurality of battery cells for installation in an electrified motor vehicle, wherein the battery cell comprises:
a cell core; and
a hybrid cell housing which is configured as a combination of an inner subhousing with an outer subhousing; and
a protection apparatus configured to, in the event of a fault, eject the cell core with the inner subhousing from the outer subhousing.

10. The battery cell according to claim 9,
wherein the outer subhousing is open in an ejection direction and has a seal in an opposite direction,
wherein the inner subhousing with the cell core is arranged in the outer subhousing in such a way that a gas-tight cavity exists between the inner subhousing and the seal and in which, by introducing gas, pressure can be built up which can be used to eject the inner subhousing in the ejection direction.

11. The battery cell according to claim 9,
wherein the inner subhousing has a first contacting cover with no material weakness in an ejection direction, and a second contacting cover with material weakness in an opposite direction.

12. The battery cell according to claim 9, comprising:
an electrically conductive spring apparatus that is pretensioned in a gas-tight cavity in such a way that, after ejection, the electrically conductive spring apparatus serves in an untensioned state as a contact bypass, wherein the gas-tight cavity exists between the inner subhousing and a seal.

13. The battery cell according to claim 9, comprising:
a sliding material located between the inner subhousing and the outer subhousing.

14. The battery cell according to claim 13,
wherein the sliding material is configured as expanding and/or adhesive material and is configured to flow out after ejection.

15. The battery cell according to claim 9, comprising
a bead or a groove on the inner subhousing configured to lock the inner subhousing to the outer subhousing in both a retaining and electrically contacting fashion, wherein the bead or groove comprises terminals.

16. The battery cell according to claim 9,
wherein the inner subhousing comprises a cutting apparatus in an ejection direction.
